(19) United States
(12) Patent Application Publication
(10) Pub. No.: US 2021/0289331 A1
(43) Pub. Date: Sep. 16, 2021

(54) INFORMATION PROCESSING APPARATUS, VEHICLE SYSTEM, INFORMATION PROCESSING METHOD, AND STORAGE MEDIUM

(71) Applicant: TOYOTA JIDOSHA KABUSHIKI KAISHA, Toyota-shi (JP)

(72) Inventors: Hikaru GOTOH, Nagoya-shi (JP); Shin SAKURADA, Toyota-shi (JP); Naoki UENOYAMA, Nagoya-shi (JP); Takumi FUKUNAGA, Nisshin-shi (JP); Josuke YAMANE, Nisshin-shi (JP); Rio MINAGAWA, Nagoya-shi (JP); Soutaro KANEKO, Nagoya-shi (JP)

(73) Assignee: TOYOTA JIDOSHA KABUSHIKI KAISHA, Toyota-shi (JP)

(21) Appl. No.: 17/190,482

(22) Filed: Mar. 3, 2021

(30) Foreign Application Priority Data
Mar. 16, 2020 (JP) 2020-045524

(51) Int. Cl. H04W 4/46; G08G 1/01; G08G 1/16

(52) U.S. Cl. CPC H04W 4/46; G08G 1/161; G08G 1/0112

(57) ABSTRACT

An information processing apparatus, comprises a controller configured to perform: acquiring traveling-related data related to traveling of two or more vehicles including a first vehicle and a second vehicle; determining, based on the traveling-related data, that the first vehicle is in any one of a plurality of predefined situations; identifying, based on the traveling-related data, the second vehicle that is located in a vicinity of the first vehicle and is involved in the determined situation; determining, based on the determined situation and a preference associated with the second vehicle, an image to be transmitted to the second vehicle; and transmitting the image to the second vehicle.

### CROSS REFERENCE TO THE RELATED APPLICATION

This application claims the benefit of Japanese Patent Application No. 2020-045524, filed on Mar. 16, 2020, which is hereby incorporated by reference herein in its entirety.

### BACKGROUND

### Technical Field

The present disclosure relates to a vehicle-to-vehicle communication technology.

### Description of the Related Art

On roads, there are some cases where it is desirable that a message be conveyed between vehicles to bring about smooth traffic. For example, it is a common practice that a traveling vehicle conveys gratitude, typically, by flashing hazard lights.

In this regard, attempts have been made to convey messages other than gratitude between vehicles. For example, Patent document 1 discloses a system in which a matter to be known among vehicles (for example, presence of a dangerously driven vehicle, or the like) is notified to vehicles in the vicinity.

### CITATION LIST

Patent document 1: Japanese Patent Laid-Open No. 2017-117249

### SUMMARY

However, a technology of conveying, between vehicles, a message fit for a traveling situation of a vehicle is not widely used in the present state of affairs.

The present disclosure has been made in view of such a problem, and an object of the present disclosure is to provide a technology for allowing a message to be smoothly conveyed between vehicles.

The present disclosure in its one aspect provides an information processing apparatus, comprising a controller configured to perform: acquiring traveling-related data related to traveling of two or more vehicles including a first vehicle and a second vehicle; determining, based on the traveling-related data, that the first vehicle is in any one of a plurality of predefined situations; identifying, based on the traveling-related data, the second vehicle that is located in a vicinity of the first vehicle and is involved in the determined situation; determining, based on the determined situation and a preference associated with the second vehicle, an image to be transmitted to the second vehicle; and transmitting the image to the second vehicle.

The present disclosure in its another aspect provides a vehicle system, comprising: an on-board apparatus mounted on each of a first vehicle and a second vehicle; and a server apparatus, wherein each of the on-board apparatuses is configured to transmit traveling-related data related to traveling of the own vehicle to the server apparatus, and the server apparatus is configured to determine, based on the traveling-related data, that the first vehicle is in any one of a plurality of predefined situations, identify, based on the traveling-related data, the second vehicle that is located in a vicinity of the first vehicle and is involved in the determined situation, determine, based on the determined situation and a preference associated with the second vehicle, an image to be transmitted to the second vehicle, and transmit the image to the on-board apparatus mounted on the second vehicle.

The present disclosure in its another aspect provides an information processing method, comprising: acquiring traveling-related data related to traveling of two or more vehicles including a first vehicle and a second vehicle; determining, based on the traveling-related data, that the first vehicle is in any one of a plurality of predefined situations; identifying, based on the traveling-related data, the second vehicle that is located in a vicinity of the first vehicle and is involved in the determined situation; determining, based on the determined situation and a preference associated with the second vehicle, an image to be transmitted to the second vehicle; and transmitting the image to the second vehicle.

Another aspect can be a program for causing a computer to execute the information processing method performed by the information processing apparatus, or a computer-readable storage medium that stores the program in a non-transitory manner.

According to the present disclosure, it is possible to provide a technology that allows a message to be smoothly conveyed between vehicles.

### BRIEF DESCRIPTION OF THE DRAWINGS

FIG. 1 is an outline diagram of a system in a first embodiment;

FIG. 2 is system configuration diagrams of a server apparatus and an on-board apparatus according to the first embodiment;

FIG. 3 is an example of positional relationship data stored in the server apparatus;

FIG. 4A illustrates a change in positional relationship between vehicles in an event;

FIG. 4B illustrates a change in positional relationship between vehicles in an event;

FIG. 4C illustrates a change in positional relationship between vehicles in an event;

FIG. 4D illustrates a change in positional relationship between vehicles in an event;

FIG. 5 is an example of image sets stored in the server apparatus;

FIG. 6 is a flowchart of processing performed by the server apparatus in the first embodiment; and

FIG. 7 is a flowchart of processing performed by the server apparatus in a second embodiment.

### DESCRIPTION OF THE EMBODIMENTS

An information processing apparatus (server apparatus) according to an embodiment collects data related to traveling of a plurality of vehicles and, based on the data, determines occurrence of a specific situation among a plurality of predefined situations, such as “giving right of way” and “problematic driving behavior”. Based on a result of the determination, image data is transmitted to a vehicle involved in the situation.

For example, when there is a vehicle that is given right of way, image data expressing gratitude is transmitted to a vehicle that gives the right of way.

The information processing apparatus according to the present embodiment includes a controller configured to perform: acquiring traveling-related data related to traveling of two or more vehicles including a first vehicle and a second vehicle; determining, based on the traveling-related data, that the first vehicle is in any one of a plurality of predefined situations; identifying, based on the traveling-related data, the second vehicle that is located in a vicinity of the first vehicle and is involved in the determined situation; determining, based on the determined situation and a preference associated with the second vehicle, an image to be transmitted to the second vehicle; and transmitting the image to the second vehicle.

The traveling-related data is data related to traveling of a vehicle and includes, for example, position information on the vehicle and information related to a speed, a traveling direction, a traveling lane, and the like of the vehicle. For example, the information processing apparatus periodically collects the traveling-related data on the plurality of vehicles and, based on the data, determines that the first vehicle is in any one of the plurality of predefined situations.

The plurality of predefined situations may be any situations in which it is desirable that communication be performed between vehicles, for example, “given right of way”, “cutting in a line of vehicles”, “catching up with a low-speed vehicle”, and the like.

“A vehicle is in a specific situation” can translate into “a specific event has occurred with respect to the vehicle”.

Further, the controller identifies the second vehicle involved in the determined situation. The second vehicle is a destination vehicle to which a message is conveyed, and may be, for example, “a vehicle that has given right of way to the first vehicle”, “a following vehicle in front of which the first vehicle has cut in”, “a vehicle caught up with by the first vehicle”, or the like.

The controller determines the image that accords with the determined situation and with the preference associated with the second vehicle, and transmits the image to the second vehicle. According to such a configuration, a message fit for a situation can be conveyed to an occupant of the second vehicle.

The information processing apparatus may further include a storage unit configured to store an image set in which an image is defined for each of the plurality of situations, and the controller may extract the image corresponding to the determined situation from the image set.

The storage unit may store a plurality of the image sets that have different themes, respectively, and the controller may extract the image corresponding to the determined situation from an image set that has a theme corresponding to the preference.

An image set is a set of images that are defined for situations, respectively. Such an image set is prepared for each theme, and a theme matching with the preference associated with the second vehicle (for example, a preference of the occupant of the second vehicle) is selected, whereby a message fit for a situation can be conveyed with an expression that is easy for the occupant of the second vehicle to accept.

The information processing apparatus according to the present embodiment may further include a storage unit that stores positional relationship data in which a change in positional relationship between a plurality of vehicles is defined for each of the plurality of situations, and the controller may determine the situation corresponding to the first vehicle, based on the positional relationship data.

The controller may identify the second vehicle, further based on the situation corresponding to the first vehicle and the positional relationship data.

The situation corresponding to the first vehicle can be determined, based on data that indicates changes over time in positions of the plurality of vehicles. Moreover, based on the data, it can be determined which ones of the plurality of vehicles are the first vehicle and the second vehicle.

The controller may determine the preference, based on a result of communication with the second vehicle.

The controller may determine the preference, based on information transmitted from a terminal that is present in the second vehicle.

Data related to the preference may be acquired directly from the second vehicle (or an on-board apparatus mounted on the second vehicle), or may be determined based on the information transmitted from the terminal (for example, a smartphone or the like owned by the occupant) that is present in the second vehicle.

The traveling-related data may include data for declaring, from the first vehicle side, that any one of the plurality of situations has occurred.

Prompt communication can be performed by determining a situation based on a declaration from an apparatus (for example, an on-board apparatus, a mobile terminal, or the like) mounted on the first vehicle.

The controller may transmit the determined image to the second vehicle by being triggered by an instruction from the first vehicle.

The image may be automatically transmitted to the second vehicle, or may be transmitted based on the instruction indicated by the apparatus (for example, the on-board apparatus, the mobile terminal, or the like) mounted on the first vehicle. For example, the information processing apparatus may notify the first vehicle that the first vehicle is in a situation where it is desirable to transmit an image to the second vehicle, and the image may be transmitted only when a consent is received from an occupant of the first vehicle.

Hereinafter, embodiments of the present disclosure will be described based on drawings. Configurations according the embodiments below are presented for illustrative purposes, and the present disclosure is not limited to the configurations according to the embodiments.

### First Embodiment

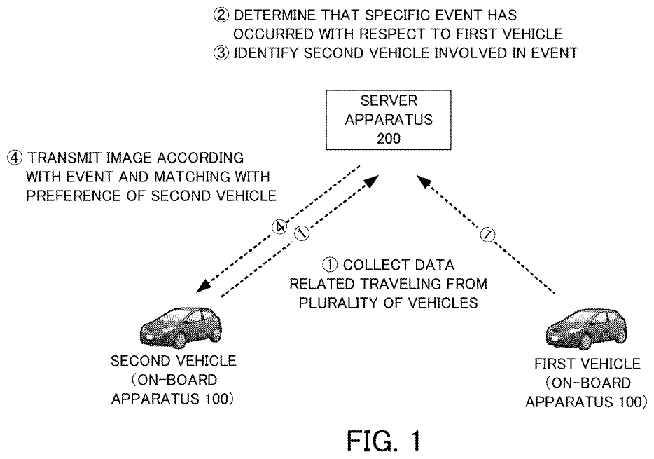

An outline of a vehicle system according to a first embodiment will be described with reference to FIG. 1. The vehicle system according to the present embodiment includes an on-board apparatus 100 mounted on each of a plurality of vehicles, and a server apparatus 200 that monitors traveling of the vehicles on each of which the on-board apparatus 100 is mounted, and transmits an image to any on-board apparatus 100, according to an occurring event.

The on-board apparatus 100 is a computer mounted on a vehicle. The on-board apparatus 100 includes a function of generating data related to traveling (hereinafter, traveling-related data) of the vehicle on which the on-board apparatus 100 is mounted and transmitting the traveling-related data to the server apparatus 200, and a function of receiving an image from the server apparatus 200 and providing the image to an occupant.

Note that the on-board apparatus 100 may be any apparatus that moves with the vehicle, and does not need to be an apparatus fixed to the vehicle. For example, the on-board apparatus 100 may be a mobile terminal or the like owned by the occupant. In the present embodiment, a description will be given on an assumption that the on-board apparatus 100 is a component of the vehicle.

The server apparatus 200 collects traveling-related data from the plurality of on-board apparatus 100 under management and, based on the data, determines that a specific situation has occurred with respect to a specific vehicle (hereinafter, first vehicle). The server apparatus 200 identifies a vehicle involved in the situation (hereinafter, second vehicle) and transmits an image according with the situation to the second vehicle. Thus, an appropriate message can be conveyed to the vehicle involved in the situation caused by the first vehicle.

In the present embodiment, a situation caused by the first vehicle is referred to as “event”.

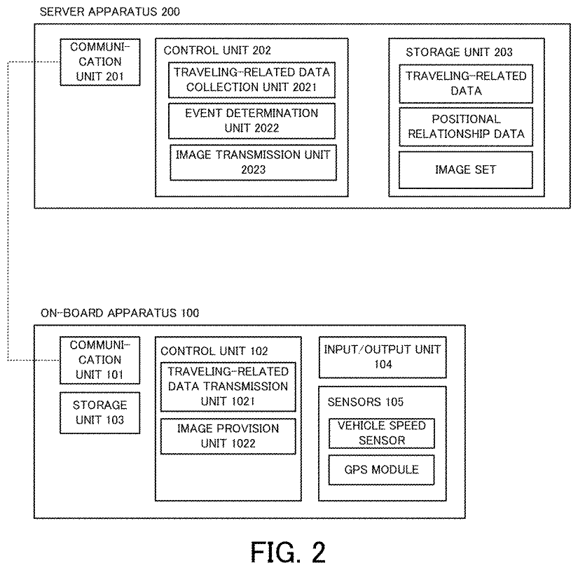

Next, components of the system will be described with reference to FIG. 2.

The on-board apparatus 100 is a computer mounted on a vehicle. The on-board apparatus 100 includes a communication unit 101, a control unit 102, a storage unit 103, an input/output unit 104, and sensors 105.

The communication unit 101 is a communication interface for wireless communication performed with the server apparatus 200. A communication scheme used by the communication unit 101 may be any scheme, such as Wi-Fi®, DSRC (Dedicated Short Range Communications), cellular communication, or millimeter-wave communication.

The control unit 102 is an arithmetic logic unit that governs control performed by the on-board apparatus 100. The control unit 102 can be implemented by using a processing unit such as a CPU.

The control unit 102 includes two function modules, namely, a traveling-related data transmission unit 1021 and an image provision unit 1022. Each function module may be implemented by executing a stored program, by using the CPU.

The traveling-related data transmission unit 1021 generates traveling-related data, based on sensor data acquired from the sensors 105. The traveling-related data is, for example, at least one of position information on the vehicle, a speed, a traveling direction, a traveling lane, a steering angle, an acceleration, and the like of the vehicle, but may include others. In the present embodiment, data indicating the vehicle speed, the position information, and the traveling lane is used for the traveling-related data. The traveling-related data transmission unit 1021 periodically generates traveling-related data and transmits the traveling-related data to the server apparatus 200.

The image provision unit 1022 receives image data transmitted from the server apparatus 200 and outputs the image data via the input/output unit 104, which will be described later. Although an image is outputted by using the input/output unit that is provided to the on-board apparatus in the present embodiment, an image may be provided via a terminal owned by a user. In other words, the image provision unit 1022 may transfer the image received from the server apparatus 200 to the terminal.

The storage unit 103 includes a main memory and an auxiliary storage device. The main memory is a memory on which a program to be executed by the control unit 102 and data to be used by the control program are expanded. The auxiliary storage device is a device in which the program to be executed by the control unit 102 and the data to be used by the control program are stored.

The input/output unit 104 is an interface for receiving as input and outputting information. The input/output unit 104 includes, for example, a display device and a touch panel. Further, the input/output unit 104 may include a keyboard, a speaker, a touch screen, or the like.

The sensors 105 include a sensor configured to acquire a speed of, position information on, and the like of the own vehicle. The sensors 105 include, for example, a vehicle speed sensor, a GPS module, and the like. Sensor data acquired by any sensor included in the sensors 105 is transmitted to the control unit 102 (traveling-related data transmission unit 1021) at any time. Note that the sensors 105 do not necessarily need to be incorporated in the on-board apparatus 100. For example, the sensors 105 may be components of the vehicle on which the on-board apparatus 100 is mounted.

The server apparatus 200 can be configured by using a general-purpose computer. In other words, the server apparatus 200 may be configured as a computer including a processor such as a CPU or a GPU, a main memory such as a RAM or a ROM, and an auxiliary storage device such as an EPROM, a hard disk drive, or a removable medium. The removable medium may be, for example, a USB memory, or a disk recording medium such as a CD or a DVD. The auxiliary storage device stores an operating system (OS), various programs, various tables, and the like, and each function matching with a predetermined purpose, which will be described later, can be implemented by loading and executing the programs stored in the auxiliary storage device on a work area of the main memory, and by controlling each constituent unit and the like through the execution of the programs. However, one or some, or all, of the functions may be implemented by a hardware circuit such as an ASIC or an FPGA.

The server apparatus 200 includes a communication unit 201, a control unit 202, and a storage unit 203.

The communication unit 201 is a communication interface for wireless communication performed with each on-board apparatus 100. A communication scheme used by the communication unit 201 may be any scheme, such as Wi-Fi®, DSRC (Dedicated Short Range Communications), cellular communication, or millimeter-wave communication. The communication unit 201 may perform communication with each on-board apparatus 100 through a wide area network such as the Internet.

The control unit 202 is an arithmetic logic unit that governs control performed by the server apparatus 200. The control unit 202 can be implemented by using a processing unit such as a CPU.

The control unit 202 includes three function modules, namely, a traveling-related data collection unit 2021, an event determination unit 2022, and an image transmission unit 2023. Each function module may be implemented by executing a stored program, by using the CPU.

In the description below, a vehicle that causes an event will be referred to as first vehicle, and a vehicle that receives an image in relation to the event will be referred to as second vehicle.

The traveling-related data collection unit 2021 periodically receives, from the on-board apparatus 100 mounted on each vehicle (both the first vehicle and the second vehicle) under management, data related to traveling (traveling-related data) of the vehicle. The received traveling-related data is accumulated in the storage unit 203, which will be described later.

The event determination unit 2022 determines, based on the accumulated traveling-related data, that an event has occurred with respect to any one of the vehicles under management.

The image transmission unit 2023 identifies the vehicles (the first vehicle and the second vehicle) involved in the occurring event, determines an image to be transmitted to the second vehicle from among images stored in the storage unit 203, which will be described later, and transmits the image.

The storage unit 203 includes a main memory and an auxiliary storage device. The main memory is a memory on which a program to be executed by the control unit 202 and data to be used by the control program are expanded. The auxiliary storage device is a device in which the program to be executed by the control unit 202 and the data to be used by the control program are stored.

Moreover, the storage unit 203 stores the traveling-related data collected by the traveling-related data collection unit 2021, data (positional relationship data) for determining occurrence of an event, and an image set.

Here, the positional relationship data and the image set will be described.

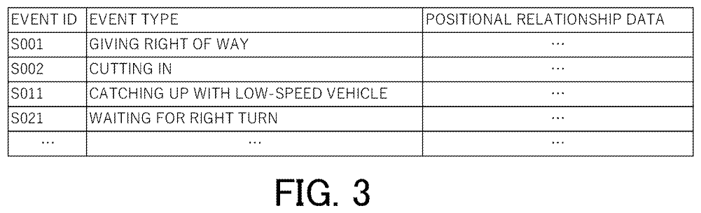

The positional relationship data is data in which a change in positional relationship between a plurality of vehicles are defined for each event. FIG. 3 is an example of a table storing the positional relationship data. In the example, an identifier of a situation (event) and positional relationship data are associated with each other.

Hereinafter, a change in positional relationship between vehicles will be described by event type.

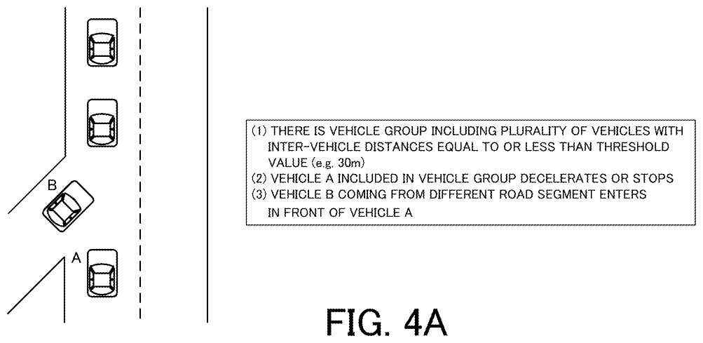

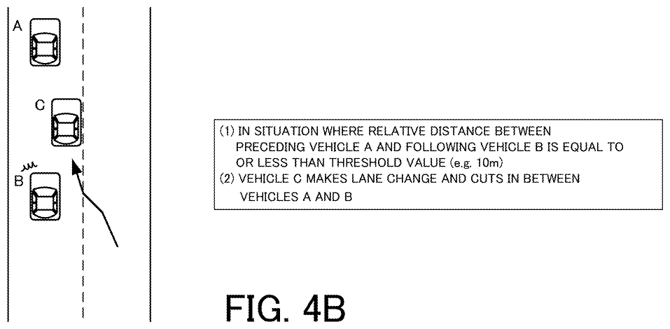

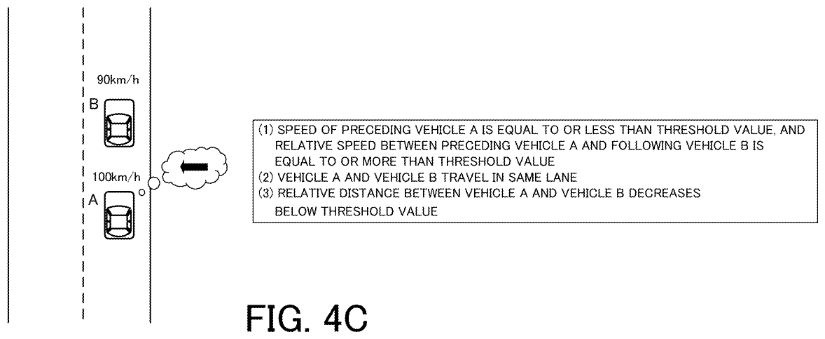

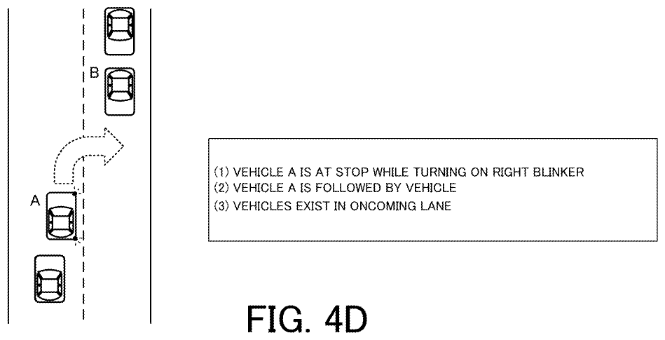

FIG. 4A illustrates a change in positional relationship between vehicles, in an event of “giving right of way”. For example, the event of “giving right of way” is established when there is a vehicle group including a plurality of vehicles with inter-vehicle distances equal to or less than a threshold value; one (vehicle A) of the vehicles included in the vehicle group decelerates or stops; and a vehicle B coming from a different road segment enters in front of the vehicle A.

When such a change in positional relationship is seen, the server apparatus can determine “occurrence of an event in which the vehicle A gives right of way to the vehicle B”.

In such a case, the server apparatus determines that the vehicle B is the first vehicle and the vehicle A is the second vehicle, and transmits, to the second vehicle, an image conveying gratitude.

FIG. 4B illustrates a change in positional relationship between vehicles, in an event of “cutting in”. For example, the event of “cutting in” is established when, in a situation where a relative distance between a preceding vehicle A and a following vehicle B is equal to or less than a threshold value, a vehicle C makes a lane change and cuts in between the vehicles A and B.

When such a change in positional relationship is seen, the server apparatus can determine “occurrence of an event in which the vehicle C cuts in front of the vehicle B”.

In such a case, the server apparatus determines that the vehicle C is the first vehicle and the vehicle B is the second vehicle, and transmits, to the second vehicle, an image conveying apology.

FIG. 4C illustrates a change in positional relationship between vehicles, in an event of “catching up with a low-speed vehicle”. For example, the event of “catching up with a low-speed vehicle” is established when a speed of a preceding vehicle B is equal to or less than a threshold value, and a relative speed between the preceding vehicle B and a following vehicle A is equal to or more than a threshold value; the vehicle A and the vehicle B travel in the same lane; and a relative distance between the vehicle A and the vehicle B decreases below a threshold value.

When such a change in positional relationship is seen, the server apparatus can determine that “the vehicle A has caught up with the vehicle B”.

In such a case, the server apparatus determines that the vehicle A is the first vehicle and the vehicle B is the second vehicle, and transmits, to the second vehicle, an image notifying that a following vehicle has caught up.

FIG. 4D illustrates a change in positional relationship between vehicles, in an event of “waiting for a right turn”. For example, the event of “waiting for a right turn” is established when a vehicle A is at a stop while turning on the right blinker; the vehicle A is followed by a vehicle; and vehicles exist in an oncoming lane (in a case of left-hand traffic).

When such a change in positional relationship is seen, the server apparatus can determine that “the vehicle A wants a vehicle B to make a halt”.

In such a case, the server apparatus determines that the vehicle A is the first vehicle and the vehicle B is the second vehicle, and transmits, to the second vehicle, an image notifying asking for a halt for a right-turning vehicle.

In such manners, the server apparatus (event determination unit 2022) identifies occurrence of an event with respect to any vehicle and identifies the first vehicle and the second vehicle as vehicles involved in the event, by acquiring a change over time in positional relationship between vehicles based on the collected traveling-related data and comparing the change in positional relationship between the vehicles with the positional relationship data.

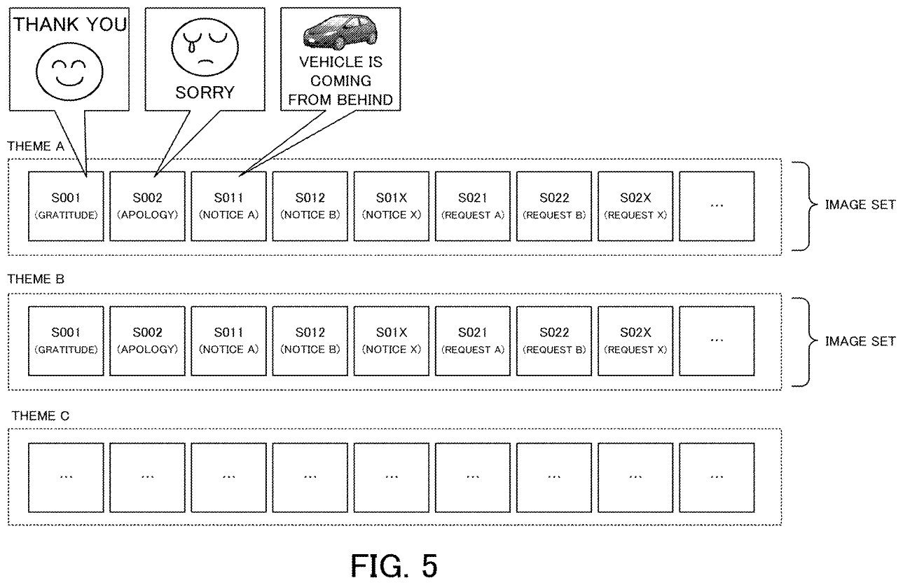

Image data is data in which images to be transmitted to the second vehicle is defined for each event. FIG. 5 is an example of the image data stored in the storage unit 203. In the present example, different images are stored for different situations. In the present example, for example, an image expressing gratitude is defined as an image corresponding to an event (S001), and an image expressing apology is defined as an image corresponding to an event (S002). A set of such images is referred to as image set.

Moreover, the storage unit 203 stores a plurality of image sets for themes, respectively. The plurality of image sets for the different themes are different only in expressing fashion, and a message to be conveyed in each event is the same. For example, both of the image corresponding to the event (S001) for a theme A and the image corresponding to the event (S001) for a theme B are images expressing gratitude.

The server apparatus (image transmission unit 2023) selects an image fit for an occurring event from an image set for a theme matching with the second vehicle that is a destination of the image.

The theme matching with the second vehicle can be determined based on preference data associated with the second vehicle. The preference data is data that directly or indirectly indicates which theme an occupant of the second vehicle prefers.

The preference data may be stored beforehand by the server apparatus, or may be transmitted from the on-board apparatus 100 by being included in the traveling-related data. The server apparatus stores an identifier of the second vehicle and the preference data in association with each other and makes use as necessary.

The preference data may be generated at any time, based on information acquired from a terminal associated with the occupant of the second vehicle. For example, a mobile terminal (for example, a smartphone) owned by the occupant of the second vehicle may be associated with the on-board apparatus 100 beforehand, and the mobile terminal and the server apparatus 200 may transmit and receive predetermined data, whereby it may be determined what preference (for example, a preference for a specific character, or the like) the occupant of the second vehicle has. Such data may be transmitted and received via the on-board apparatus 100.

Examples of the predetermined data include a list of applications installed in the smartphone, a transmission and reception history of messages, a history of position information on the terminal, and the like. For example, when the preference data indicates a preference for a specific character, an image set for a theme that is the character may be selected.

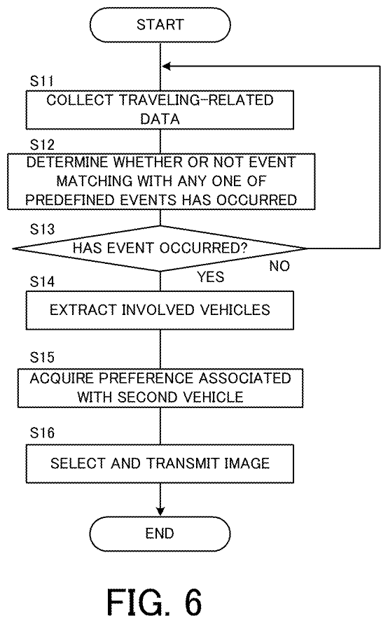

Next, processing performed by the server apparatus 200 will be described with reference to FIG. 6. The processing illustrated in FIG. 6 is performed in each predetermined period.

First, in step S11, the traveling-related data collection unit 2021 collects traveling-related data from the on-board apparatuses 100 mounted on the vehicles under management. Note that in the present step, the server apparatus may request the traveling-related data from the on-board apparatuses 100, or the on-board apparatuses 100 may transmit the traveling-related data to the server apparatus 200 in a push manner. The collected traveling-related data is sequentially accumulated in the storage unit 203.

In step S12, the event determination unit 2022 determines, based on the accumulated traveling-related data, whether or not an event matching with any one of the predefined events has occurred recently.

Specifically, traveling-related data in most recent predetermined period is extracted, and time-series data indicating changes in position information on (and speed of) each vehicle is generated. It is determined whether or not an event has occurred, by comparing the time-series data with the above-described positional relationship data.

Here, when it is determined that any event has occurred (step S13—Yes), the processing advances to step S14, and vehicles involved in the event are extracted. The extraction of the vehicles can be performed based on a positional relationship as described above. In the present step, the first vehicle, which is a vehicle causing the event, and the second vehicle, which is a destination to which a message is transmitted, are identified.

In step S15, the image transmission unit 2023 acquires preference data associated with the second vehicle, and determines a theme of an image.

In step S16, the image transmission unit 2023 acquires an image that has the determined theme and that corresponds to the determined event, and transmits the image to the on-board apparatus 100 mounted on the second vehicle. The transmitted image is presented to the occupant of the second vehicle via the input/output unit 104 included in the on-board apparatus 100. At the time, arrival of a message may be notified by using sound or the like.

As described above, according to the first embodiment, occurrence of an event caused by the first vehicle can be automatically determined by the server apparatus, and an image corresponding to the event can be transmitted to the second vehicle involved in the event. Since the image is an image that accords with a theme that accords with a preference of the second vehicle, a message fit for a situation can be conveyed with an expression that is easy for the second vehicle to accept.

### Modification Example of the First Embodiment

In the first embodiment, when the first vehicle is in a specific situation, the server apparatus 200 automatically transmits an image to the second vehicle. However, transmission of an image may be triggered based on an instruction from the occupant of the first vehicle. For example, after the first vehicle and the second vehicle are extracted in step S14, it may be inquired of the on-board apparatus 100 mounted on the first vehicle whether or not to perform transmission of an image, and it may be determined, in accordance with an acquired answer, whether or not to perform transmission of an image.

### Second Embodiment

Although the server apparatus 200 determines occurrence of an event in the first embodiment, the on-board apparatus 100 mounted on the first vehicle may declare occurrence of an event to the server apparatus 200 at a stage before the server apparatus 200 determines occurrence of an event.

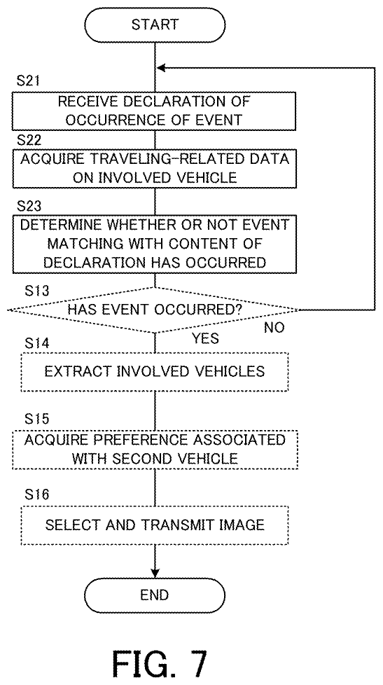

FIG. 7 is a flowchart of processing performed by the server apparatus 200 in a second embodiment.

In the present embodiment, the on-board apparatus 100 mounted on the first vehicle transmits data for declaring occurrence of an event (hereinafter, declaration data) to the server apparatus 200 at an arbitrary timing. For example, the on-board apparatus 100 provides options via the input/output unit 104, and the occupant selects any one event.

The declaration data is transmitted to the server apparatus 200, for example, together with the traveling-related data (step S21). When the declaration data is received, the server apparatus 200 extracts traveling-related data on one or more vehicles that are close to the first vehicle in terms of distance and time (step S22), and determines whether or not a change in positional relationship between the plurality of vehicles matches with the declared event (step S23).

Processing in and after step S13 is similar to the first embodiment, and therefore a description thereof is omitted.

According to the second embodiment, occurrence of an event can be conveyed to the server apparatus 200 through an operation made by the occupant of the first vehicle. In other words, an image corresponding to an event can be transmitted to the second vehicle without a time lag.

Note that although in step S23, the server apparatus 200 determines whether or not an event matching with a content of the declaration has occurred in the present example, such a step may be omitted. In such a case, the server apparatus 200 may determine the second vehicle based on the declaration data. For example, data specifying a position of the second vehicle may be attached to the declaration data and transmitted from the on-board apparatus 100 mounted on the first vehicle to the server apparatus 200.

### Third Embodiment

In the first and second embodiments, the server apparatus 200 serves as an entity to perform determination of an event and transmission of an image. In contrast, a third embodiment is configured such that processing for such determination and transmission is completed by a plurality of on-board apparatuses 100.

In the third embodiment, the positional relationship data and the image data are stored in the on-board apparatuses 100 (storage unit 103).

In the third embodiment, the plurality of on-board apparatuses 100 mounted on a plurality of vehicles share the traveling-related data by mutually transmitting and receiving the traveling-related data through vehicle-to-vehicle communication. In other words, the traveling-related data on the own vehicle and the traveling-related data on the vehicle traveling in the vicinity are accumulated in the storage unit 103.

In the third embodiment, the on-board apparatus 100 determines whether or not an event has occurred and identifies a counterpart vehicle (second vehicle), based on the accumulated traveling-related data and the positional relationship data. A method for the determination and identification is similar to the method in the first embodiment. Occurrence of an event may be determined based on a declaration from the occupant of the first vehicle, as in the second embodiment. At the time, the occupant of the first vehicle may specify a position of the second vehicle.

The on-board apparatus 100 mounted on the first vehicle determines an image to transmit to the on-board apparatus 100 mounted on the second vehicle through a method similar to the method in the first embodiment, and transmits the image through vehicle-to-vehicle communication.

According to the third embodiment, transmission and reception of an image can be performed without intervention of the server apparatus.

### Modification Example

The above-described embodiments are provided only for illustrative purposes, and the present disclosure can be carried out with appropriate modifications made within a scope that does not depart from a gist of the present disclosure.

For example, the processing and the units described in the present disclosure can be freely combined and implemented, to the extent that there exists no technical conflict.

Although the server apparatus 200 transmits an image in the description of some embodiments, the server apparatus 200 may be configured to perform only determination of an occurring event, or determination of an image to be transmitted. In other words, the image itself may be transmitted directly from the on-board apparatus 100 mounted on the first vehicle to the on-board apparatus 100 mounted on the second vehicle.

In addition to an image described in the embodiments, the server apparatus 200 may acquire information for allowing the occupant of the second vehicle to identify the first vehicle, and may transmit the information to the on-board apparatus 100 mounted on the second vehicle. Examples of such information include a license plate information on the first vehicle, and information related to an external appearance (external appearance image or the like) of the first vehicle.

The processing described as being performed by a single apparatus may be performed by a plurality of apparatuses in a divided manner. Alternatively, the processing described as being performed by different apparatuses may be performed by a single apparatus. It can be flexibly changed what hardware component or components (server component or components) are used to implement each function in a computer system.

The present disclosure can also be implemented in such a manner that a computer program packaging the functions described in the embodiments above is provided to a computer, and that one or more processors included in the computer read and execute the program. Such a computer program may be provided to the computer by using a non-transitory computer-readable storage medium that can connect to a system bus of the computer, or may be provided to the computer via a network. Examples of the non-transitory computer-readable storage medium include any types of disks such as magnetic disks (Floppy® disk, hard disk drive (HDD), and the like) and optical disks (CD-ROM, DVD disk, Blu-ray Disc, and the like), a read only memory (ROM), a random access memory (RAM), an EPROM, an EEPROM, a magnetic card, a flash memory, an optical card, and any types of media suitable to store electronic instructions.

What is claimed is:

1. An information processing apparatus, comprising a controller configured to perform:
acquiring traveling-related data related to traveling of two or more vehicles including a first vehicle and a second vehicle;
determining, based on the traveling-related data, that the first vehicle is in any one of a plurality of predefined situations;
identifying, based on the traveling-related data, the second vehicle that is located in a vicinity of the first vehicle and is involved in the determined situation;
determining, based on the determined situation and a preference associated with the second vehicle, an image to be transmitted to the second vehicle; and
transmitting the image to the second vehicle.

2. The information processing apparatus according to claim 1, further comprising
a storage configured to store an image set in which an image is defined for each of the plurality of situations,
wherein the controller extracts the image corresponding to the determined situation from the image set.

3. The information processing apparatus according to claim 2, wherein
the storage stores a plurality of the image sets that have different themes, respectively, and
the controller extracts the image corresponding to the determined situation from an image set that has a theme corresponding to the preference.

4. The information processing apparatus according to claim 1, further comprising
a storage configured to store positional relationship data in which a change in positional relationship between a plurality of vehicles is defined for each of the plurality of situations,
wherein the controller determines the situation corresponding to the first vehicle, based on the positional relationship data.

5. The information processing apparatus according to claim 4, wherein
the controller identifies the second vehicle, further based on the situation corresponding to the first vehicle and the positional relationship data.

6. The information processing apparatus according to claim 1, wherein
the controller determines the preference, based on a result of communication with the second vehicle.

7. The information processing apparatus according to claim 6, wherein
the controller determines the preference, based on information transmitted from a terminal that is present in the second vehicle.

8. The information processing apparatus according to claim 1, wherein
the traveling-related data includes data for declaring, from the first vehicle side, that any one of the plurality of situations has occurred.

9. The information processing apparatus according to claim 1, wherein
the controller transmits the determined image to the second vehicle by being triggered by an instruction from the first vehicle.

10. A vehicle system, comprising:
an on-board apparatus mounted on each of a first vehicle and a second vehicle; and
a server apparatus,
wherein each of the on-board apparatuses is configured to
transmit traveling-related data related to traveling of the own vehicle to the server apparatus, and
the server apparatus is configured to
determine, based on the traveling-related data, that the first vehicle is in any one of a plurality of predefined situations,
identify, based on the traveling-related data, the second vehicle that is located in a vicinity of the first vehicle and is involved in the determined situation,
determine, based on the determined situation and a preference associated with the second vehicle, an image to be transmitted to the second vehicle, and
transmit the image to the on-board apparatus mounted on the second vehicle.

11. The vehicle system according to claim 10, wherein
the server apparatus stores an image set in which an image is defined for each of the plurality of situations, and extracts the image corresponding to the determined situation from the image set.

12. The vehicle system according to claim 11, wherein
the server apparatus stores a plurality of the image sets that have different themes, respectively, and extracts the image corresponding to the determined situation from an image set that has a theme corresponding to the preference.

13. The vehicle system according to claim 10, wherein
the server apparatus stores positional relationship data in which a change in positional relationship between a plurality of vehicles is defined for each of the plurality of situations, and determines the situation corresponding to the first vehicle, based on the positional relationship data.

14. The vehicle system according to claim 13, wherein
the server apparatus identifies the second vehicle, further based on the situation corresponding to the first vehicle and the positional relationship data.

15. The vehicle system according to claim 10, wherein
the server apparatus determines the preference, based on a result of communication with the on-board apparatus mounted on the second vehicle.

16. The vehicle system according to claim 15, wherein
the server apparatus determines the preference, based on information transmitted from a terminal that is present in the second vehicle.

17. The vehicle system according to claim 10, wherein
the on-board apparatus mounted on the first vehicle is configured to be able to declare, to the server apparatus, that any one of the plurality of situations has occurred.

18. The vehicle system according to claim 10, wherein
the server apparatus transmits the determined image to the on-board apparatus mounted on the second vehicle by being triggered by an instruction from the on-board apparatus mounted on the first vehicle.

19. An information processing method, comprising:
acquiring traveling-related data related to traveling of two or more vehicles including a first vehicle and a second vehicle;
determining, based on the traveling-related data, that the first vehicle is in any one of a plurality of predefined situations;
identifying, based on the traveling-related data, the second vehicle that is located in a vicinity of the first vehicle and is involved in the determined situation;
determining, based on the determined situation and a preference associated with the second vehicle, an image to be transmitted to the second vehicle; and
transmitting the image to the second vehicle.

20. A non-transitory computer readable storing medium recording a computer program for causing a computer to perform the information processing method according to claim 19.
